(19) United States
(12) Patent Application Publication
(10) Pub. No.: US 2018/0116185 A1
(43) Pub. Date: May 3, 2018

(54) AQUATIC PLATFORM/RESTING AREA FOR AQUARIUM FISH AND OTHER AQUATIC OR SEMI-AQUATIC AQUARIUM ANIMALS

(71) Applicant: ZOO MED LABORATORIES, INC., San Luis Obispo, CA (US)

(72) Inventor: Gary Wayne Bagnall, Arroyo Grande, CA (US)

(21) Appl. No.: 15/342,569

(22) Filed: Nov. 3, 2016

(51) Int. Cl. A01K 63/00

(52) U.S. Cl. CPC A01K 63/006

(57) ABSTRACT

An aquatic device includes a support post including a first end and a second end, and a platform assembly secured to the support post for movement relative thereto. The platform assembly includes a platform member shaped and dimensioned to extend transversely to a longitudinal axis of the support post, a float member and a central support member to which both the platform member and the float member are secured. The central support member includes a passageway extending along a length of the central support member. The passageway is shaped and dimensioned to fit over the support post such that the platform assembly may freely move along the length of the support post. When the aquatic device is positioned within an aquarium with the support post extending toward an upper surface of water within the aquarium with the second end of the support post extending near or above the upper surface of water within the aquarium, buoyancy of the float member causes the float member to sit at the upper surface of water within the aquarium and thereby support the platform member at a position adjacent the upper surface of water within the aquarium.

### BACKGROUND OF THE INVENTION

### 1. Field of the Invention

The invention relates to an aquatic platform/resting area for aquarium fish and other aquatic or semi-aquatic animals.

### 2. Description of the Related Art

Many aquarium fish and other aquatic or semi-aquatic aquarium animals (frogs, newts, salamanders, etc) desire to remain submerged within water, but simultaneously remain at a position adjacent the upper surface of the water. This allows easy to access to air, as well as other environmental elements that might be required. However, conventional aquarium devices all sit at positions well below the upper surface of the water, and therefore do not offer aquarium fish and other aquatic or semi-aquatic aquarium animals the structure necessary to support them at positions adjacent the upper surface of the water.

### SUMMARY OF THE INVENTION

It is, therefore, an object of the present invention to provide an aquatic device having a support post and a platform assembly secured to the support post for movement relative thereto. The platform assembly includes a platform member shaped and dimensioned to extend transversely to a longitudinal axis of the support post, a float member, and a central support member to which both the platform member and the float member are secured. The central support member includes a passageway extending along a length of the central support member. The passageway is shaped and dimensioned to fit over the support post such that the platform assembly may freely move along the length of the support post. When the aquatic device is positioned within an aquarium with the support post extending toward an upper surface of water within the aquarium with the second end of the support post extending near or above the upper surface of water within the aquarium, buoyancy of the float member causes the float member to sit at the upper surface of water within the aquarium and thereby support the platform member at a position adjacent the upper surface of water within the aquarium.

It is also an object of the present invention to provide an aquatic device wherein the support post is constructed as a straight, vertical rail.

It is another object of the present invention to provide an aquatic device wherein the support post is a one-piece construction.

It is a further object of the present invention to provide an aquatic device wherein the float member is a plastic ball with air inside that can remain buoyant.

It is also an object of the present invention to provide an aquatic device wherein the float member is composed of foam and is integrally formed with the central support member.

It is another object of the present invention to provide an aquatic device wherein the platform member includes an upper surface and a lower surface.

It is a further object of the present invention to provide an aquatic device wherein the platform member and the float member are positioned to allow for the platform member to remain partially submerged when in use.

It is also an object of the present invention to provide an aquatic device wherein the center of gravity of the float member sits above the upper surface of the platform member.

It is another object of the present invention to provide an aquatic device wherein a center of gravity of the float member sits above the upper surface of the platform member a sufficient distance to allow the upper surface of the platform member to sit submerged just below the surface of the water a distance of ¾″ to 1″.

It is a further object of the present invention to provide an aquatic device including a base member having an upper surface and a lower surface, and wherein the first end of the support post extends from the upper surface of the base member.

It is also an object of the present invention to provide an aquatic device wherein the base member is a weighted support structure shaped and dimensioned to sit upon the floor of the aquarium.

It is another object of the present invention to provide an aquatic device wherein the base member takes the form of a rock.

It is a further object of the present invention to provide an aquatic device wherein the platform member includes an upper surface facing away from the base member and a lower surface facing toward the base member.

It is also an object of the present invention to provide an aquatic device wherein the central support member is cylindrical.

It is another object of the present invention to provide an aquatic device including a mounting member for securing the support post to a wall of the aquarium.

It is a further object of the present invention to provide an aquatic device wherein the mounting member includes a support arm with a suction cup secured thereto.

It is also an object of the present invention to provide an aquatic device wherein cross section profiles of the support post and the passageway are non-circular allowing for up/down movement of the platform assembly relative to the support post but preventing rotational movement of the platform assembly relative to the support post. Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the aquatic platform/resting area in accordance with a first embodiment.

FIG. 2 is a perspective view of the aquatic platform/resting area shown in FIG. 1 within an aquarium filled with water.

FIG. 3 is a perspective view of an alternate embodiment of an aquatic platform/resting area in accordance with the present invention.

FIG. 4 is a side view of the aquatic platform/resting area as shown in FIG. 3.

FIG. 5 is a detailed perspective view of the float member and a cylindrical central support member of the aquatic platform/resting area as shown in FIGS. 3 and 4.

FIG. 6 is a cross sectional view showing an alternate embodiment for the profile of the support post and the passageway of the central support member so as to prevent rotational movement of the platform assembly relative to the support post.

### DESCRIPTION OF THE PREFERRED EMBODIMENT

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

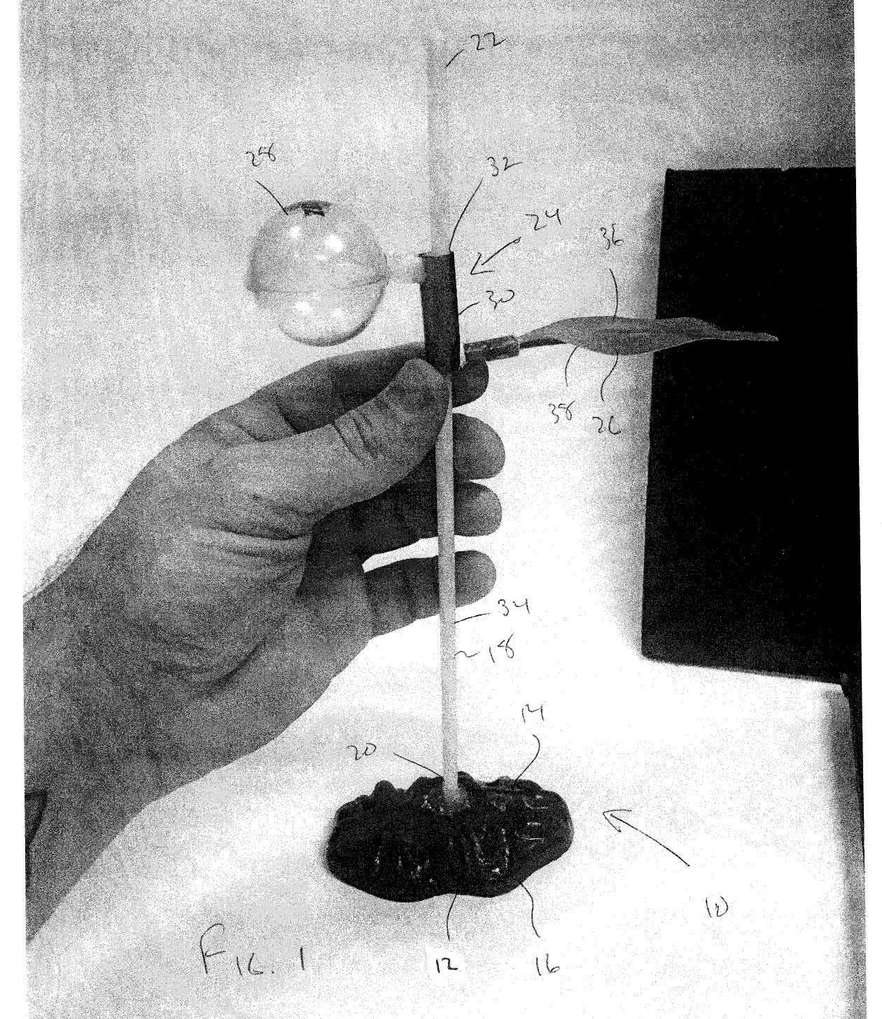

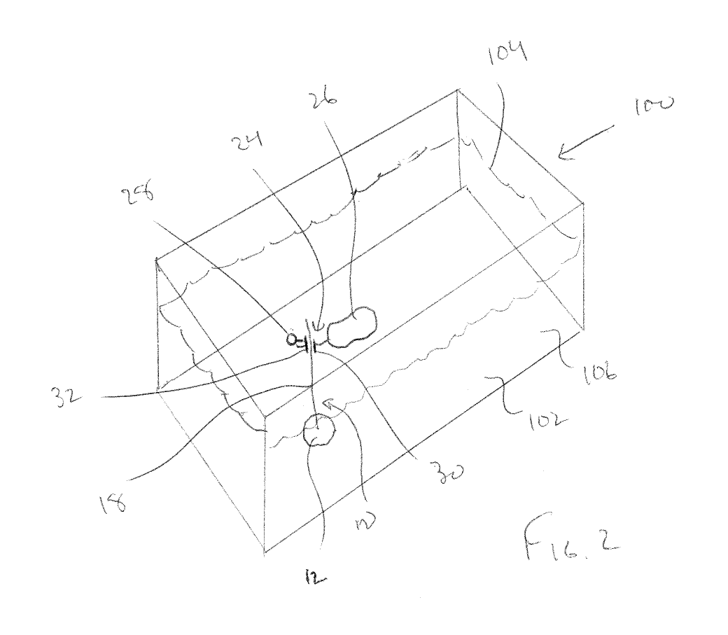

In accordance with the present invention, and with reference to FIGS. 1 and 2, an aquatic platform/resting area 10 for aquarium fish and other aquatic or semi-aquatic aquarium animals (frogs, newts, salamanders, etc.) are disclosed. The aquatic platform/resting area 10 includes a base member 12, having an upper surface 14 and a bottom surface 16, and a support post 18 extending upwardly from the base member 12. The support post 18 includes a first end 20 coupled to the base member 12 and a free second end 22. The aquatic platform/resting area 10 also includes a platform assembly 24 secured to the support post 18 for movement relative thereto. The platform assembly 24 includes a platform member 26 shaped and dimensioned to extend transversely to a longitudinal axis of the support post 18, a float member 28, and a cylindrical central support member 30 to which both the platform member 26 and the float member 28 are secured. The cylindrical central support member 30 includes a passageway 32 extending along a length of the cylindrical central support member 30, wherein the passageway 32 is shaped and dimensioned to fit over the support post 18 such that the platform assembly 24 may freely move along the length of the support post 18.

When the aquatic platform/resting area 10 is positioned within an aquarium 100 with the base member 12 positioned upon a floor 102 of the aquarium 100 and the support post 18 extending toward an upper surface 104 of water 106 within the aquarium 100 with the second end 22 of the support post 18 extending near or above the upper surface 104 of water 106 within the aquarium 100, buoyancy of the float member 28 causes the float member 28 to sit at the upper surface 104 of water 106 within the aquarium 100 and thereby support the platform member 26 at a position adjacent the upper surface 104 of water 106 within the aquarium 100.

More specifically, the base member 12 is a weighted support structure shaped and dimensioned to sit upon the floor 102 of the aquarium 100 and support the support post 18 upwardly so that the second end 22 of the support post 18 may extend near or above the upper surface 104 of the water 106 within the aquarium 100. With this in mind, the base member 12 includes a substantially flat bottom surface 16 that is adapted to sit upon the floor 102 of the aquarium 100 and an upper surface 14 from which the support post 18 extends. In accordance with a preferred embodiment, it is contemplated the base member 12 may take the form of an artificial rock, natural rock, or other item having sufficient weight to remain stationary in the aquarium 100 and also support the support post 18. It is further appreciated that base member 12 could be a suction cup that would stick to the bottom flat, smooth surface of an aquarium 100.

The support post 18 is attached to the base member 12 and extends upwardly from the upper surface 14 of the base member 12. As explained above, the support post 18 is an elongated member shaped and dimensioned to guide the platform assembly 24 as it moves upon and down the support post 18 with changes in the water level and pressure applied thereto as aquarium fish and other aquatic or semi-aquatic aquarium animals come into contact with the platform assembly 24. The support post 18 includes a first end 20 that is secured to the base member 12 and a free second end 22 that extends away from the base member 12. The support post 18 is preferably constructed as a straight, vertical rail that is attached to the base member 12 and extends to the surface 104 of the water 106. It is appreciated the support post 18 can be supplied as one long piece that is cut to a desired length, or it can be several pieces that attach end to end until a desired length is achieved. A single long piece is disclosed with reference to FIGS. 1 and 2.

As briefly discussed above, the platform assembly 24 moves relative to the support post 18, as such, the outer surface 34 of the support post 18 must be sufficiently smooth to allow for unencumbered movement of the platform assembly 24 relative to the support post 18. With this in mind, it is appreciated the support post 18 may take various forms that would enhance the aesthetic appearance of the aquatic platform/resting area 10 when positioned within the aquarium 100.

The platform assembly 24 is shaped and dimensioned for engagement with the support post 18 such that the platform assembly 24 may freely move up and down along the length of the support post 18 as the water level or pressure applied thereto causes the platform assembly 24 to move up and down. The platform assembly 24 is coupled with the support post 18 by its cylindrical central support member 30. The cylindrical central support member 30 includes a passageway 32 extending along a length of the cylindrical central support member 30 wherein the passageway 32 is shaped and dimensioned to fit over the support post 18 such that the platform assembly 24 may freely move along the length of the support post 18.

Secured to and extending from the cylindrical central support member 30 are the platform member 26 and the float member 28. The float member 28 functions a buoyant element for supporting the platform assembly 24 at the upper surface 104 of the water 106 within the aquarium 100. In accordance with the disclosed embodiment, the float member 28 is a simple plastic ball with air inside that can remain buoyant with the weight of the platform member 26 and an aquarium animal on it. It is, however, appreciated the float member 28 may be other generic sealed shapes with air inside that can remain buoyant with the weight of the platform member 26 and an aquarium animal on it. The float member 28 can also be made from foam or other buoyant material, or the float member 28 can be made to have the shape and appearance of a natural object, like a lily pad, duck, log, turtle, etc. The float member 28 may also be made to have the appearance of other items including a boat, mermaid, UFO, etc.

As to the platform member 26 it is shaped and dimensioned to provide a platform or rest area for aquarium fish and other aquatic or semi-aquatic aquarium animals, and may therefore take a variety of forms. With this in mind, the platform member 26 extends transversely to both the longitudinal axis of the support post 18 and the longitudinal axis of the passageway 32 extending through the cylindrical central support member 30. The platform member 26 includes an upper surface 36 facing away from the base member 12 and toward the upper surface 104 of the water 106 (when in use) and a lower surface 38 facing toward the base 12 and away from the upper surface 104 of the water 106 (when in use). In accordance with the disclosed embodiment, the platform member 26 has the shape of a leaf, but it can be any shape having a relatively flat surface. It could have the appearance of a submerged boat dock, rock, a bed, or any other suitable surface for aquarium animals to rest on.

The relative position of the platform member 26 and the float member 28 is important as it allows for the platform member 26 to remain slightly submerged and thereby allow a fish to move to a position above the upper surface 36 of the platform member 26. With this in mind, and considering the longitudinal axis defined by the passageway 32 of the cylindrical central support member 30, the center of gravity of the float member 28 sits above the upper surface 36 of the platform member 26 (that is, offset from the upper surface 36 of the platform member 26 in the direction of the second end 22 of the support post 18 when the platform assembly 24 is positioned thereon) a sufficient distance to allow the upper surface 36 to sit submerged just below the surface 104 of the water 106 (typically ¾″ to 1″).

In practice, the aquatic platform/resting area 10 is preferably assembled by positioning the base member 12 upon the floor 102 of the aquarium 100 with the support post 18 extending upwardly with the second end 22 thereof extending near or above the upper surface 104 of the water 106 within the aquarium 100. The platform assembly 24 is placed over the support post 18, that is, the passageway 32 of the cylindrical central support member 30 is placed over the support post 18 with the float member 28 and the platform member 26 extending laterally therefrom. The platform assembly 24 will slide down the support post 18 until the buoyancy of the float member 28 causes the platform assembly 24 to cease moving toward the base member 12 and sit upon the support post 18 adjacent to the upper surface 104 of the water 106 in the aquarium 100.

With the aquatic platform/resting area 10 properly positioned within the aquarium 100, and the platform member 26 slightly below the upper surface 104 of the water 106, the aquatic platform/resting area 10 allows air-breathing fish, like Bettas and others, to rest near the surface 104 of the water 106 which is preferred by them over resting on the floor 102 of an aquarium 100 where they have to travel longer distances to reach the water's surface. It is appreciated the positioning of the upper surface 36 of the platform member 26 relative to the float member 28 (and ultimately the upper surface 104 of the water 106) is important as the upper surface 36 of the platform member 26 cannot be at the water's surface as it would be impossible for the fish to climb onto the platform member 26, therefore the platform member 26 must be situated a set distance below the upper surface 104 of the water 106.

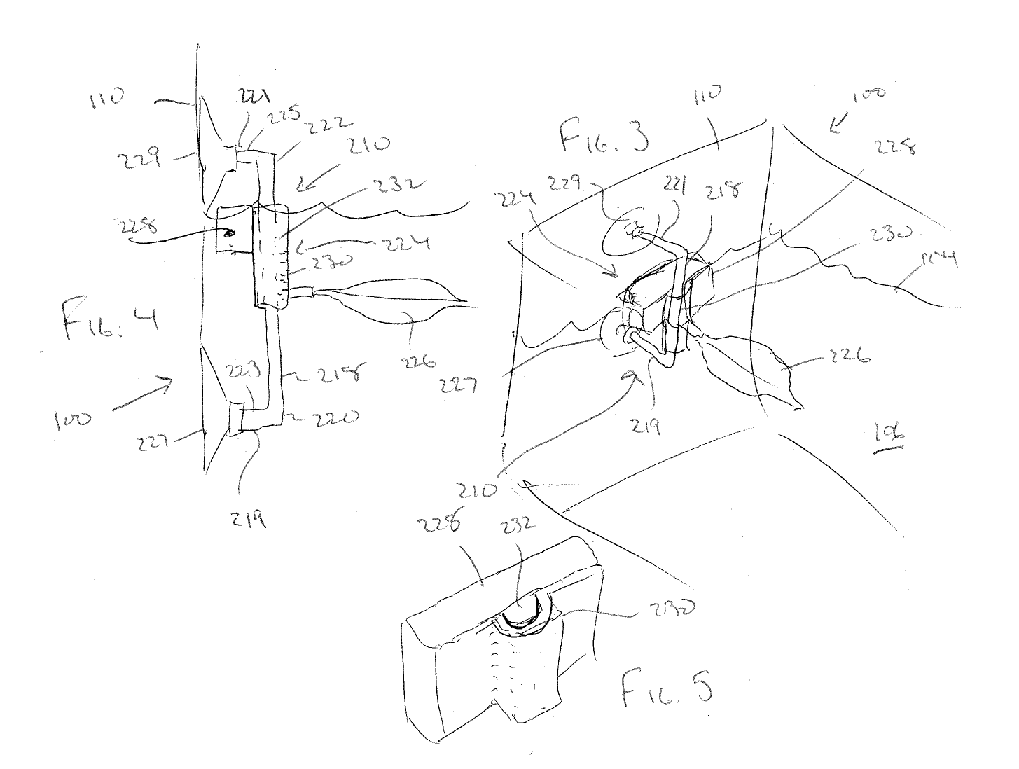

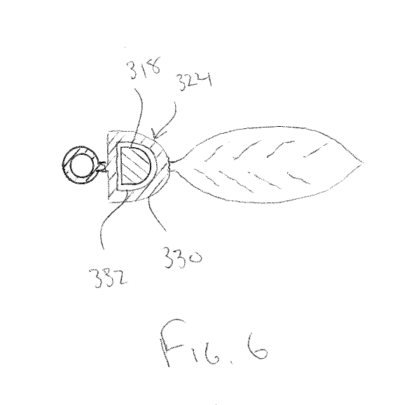

It is also contemplated support of the aquatic platform/resting area may be achieved by mounting the aquatic platform/resting area to the wall 110 of the aquarium 100 rather than the floor 102 of the aquarium 100. In accordance with such an embodiment, and with reference to FIGS. 3, 4 and 5, the aquatic platform/resting area 210 includes a support post 218 that is ultimately secured to the wall 110 of the aquarium 100 by first and second mounting members 219, 221. The support post 218 includes a first end 220 having a first mounting member 219 extending therefrom and a second end 222 with a second mounting member 221 extending therefrom. In accordance with a preferred embodiment, the first mounting member 219 includes a support arm 223 secured to the first end 220 of the support post 218 so as to extend in a direction substantially perpendicular to the longitudinal axis of the support post 218. The second mounting member 221 includes a support arm 225 secured to the second end 220 of the support post 218 so as to extend in a direction substantially perpendicular to the longitudinal axis of the support post 218. Secured to the ends of the support arms 223, 225 of the first and second mounting members 219, 221 are suction cups 227, 229 that are selectively secured to the wall 110 of the aquarium 100 as desired. While suction cups are disclosed in accordance with this embodiment it is also contemplated hooks or other securing members may be used in accordance with such an embodiment for attaching the support post to the wall of the aquarium.

The aquatic platform/resting area 210 also includes a platform assembly 224 secured to the support post 218 for movement relative thereto. The platform assembly 224 includes a platform member 226 shaped and dimensioned to extend transversely to the longitudinal axis of the support post 218, a float member 228, and a central support member 230 to which both the platform member 226 and the float member 228 are secured. The central support member 230 includes a passageway 232 extending along a length of the central support member 230, wherein the passageway 232 is shaped and dimensioned to fit over the support post 218 such that the platform assembly 224 may freely move along the length of the support post 218.

As with the prior embodiment, when the aquatic platform/resting area 210 is positioned within an aquarium 100 with the support post 218 secured to the wall 110 of the aquarium 100 and the support post 218 extending toward an upper surface 104 of water 106 within the aquarium 100 with the second end 222 of the support post 218 extending near or above the above the upper surface 104 of water 106 within the aquarium 100, buoyancy of the float member 228 causes the float member 228 to sit at the upper surface 104 of water 106 within the aquarium 100 and thereby support the platform member 226 at a position adjacent the upper surface 104 of water 106 within the aquarium 100.

As explained above in accordance with the prior embodiment, the support post 218 is an elongated member shaped and dimensioned to guide the platform assembly 224 as it moves upon and down the support post 218 with changes in the water level and pressure applied thereto as aquarium fish and other aquatic or semi-aquatic aquarium animals come into contact with the platform assembly 224. The support post 218 is constructed as a straight, vertical rail that is attached to the wall 110 of the aquarium and extends to the surface 104 of the water 106.

As with the prior embodiment, the platform assembly 224 is shaped and dimensioned for engagement with the support post 218 such that the platform assembly 224 may freely move up and down along the length of the support post 218 as the water level or pressure applied thereto causes the platform assembly 224 to move up and down. The platform assembly 224 is coupled with the support post 218 by its central support member 230. The central support member 230 includes a passageway 232 extending along a length of the central support member 230 wherein the passageway 232 is shaped and dimensioned to fit over the support post 218 such that the platform assembly 224 may freely move along the length of the support post 218.

Secured to and extending from the central support member 230 are the platform member 226 and the float member 228. The float member 228 functions as a buoyant element for supporting the platform assembly 224 at the upper surface 104 of the water 106 within the aquarium 100. In accordance with this embodiment, the float member 228 is a substantially flat foam member that can remain buoyant with the weight of the platform member 226 and an aquarium animal on it, and is also shaped and dimensioned for positioning between the wall 110 of the aquarium 100 and the support post 218 when the support post 218 is secured to the wall 110 for use. In accordance with this embodiment, it is also noted that the float member 228 and the central support member 230 are integrally formed.

As to the platform member 226, it is shaped and dimensioned to provide a platform or rest area for aquarium fish and other aquatic or semi-aquatic aquarium animals, and may therefore take a variety of forms. With this in mind, the platform member 226 extends transversely to both the longitudinal axis of the support post 218 and the longitudinal axis of the passageway 232 extending through the central support member 230. The platform member 226 includes an upper surface 236 facing the upper surface 104 of the water 106 (when in use) and a lower surface 238 facing away from the upper surface 104 of the water 106 (when in use). In accordance with the disclosed embodiment, the platform member 226 has the shape of a leaf, but it can be any shape having a relatively flat surface.

As discussed above, the relative position of the platform member 226 and the float member 228 is important as it allows for the platform member 226 to remain slightly submerged and thereby allow a fish to move to a position above the upper surface 236 of the platform member 226. The center of gravity of the float member 228, therefore, sits above the upper surface 236 of the platform member 226 (that is, offset from the upper surface 236 of the platform member 226 in the direction of the second end 222 of the support post 218 when the platform assembly 224 is positioned thereon) a sufficient distance to allow the upper surface 236 to sit submerged just below the surface 104 of the water 106 (typically ¾″ to 1″).

In practice, the aquatic platform/resting area 210 is preferably secured to the wall 110 of the aquarium 100 via the suction cups 227, 229 with the support post 218 extending upwardly with the second end 222 thereof extending near or above the upper surface 104 of the water 106 within the aquarium 100. Because of the shape of the aquatic platform/resting area 210, the platform assembly 224 will be assembled on the support post 218 during the manufacturing process. The platform assembly 224 will slide down the support post 218 until the buoyancy of the float member 228 causes the platform assembly 224 to cease downward movement and sit upon the support post 218 adjacent to the upper surface 104 of the water 106 in the aquarium 100. With the aquatic platform/resting area 210 properly positioned within the aquarium 100, and the platform member 226 slightly below the upper surface 104 of the water 106, the aquatic platform/resting area 210 allows air-breathing fish, like Bettas and others, to rest near the surface 104 of the water 106 which is preferred by them over resting on the floor 102 of an aquarium 100 where they have to travel longer distances to reach the water's surface.

Since the support post 18, 218 of the embodiments disclosed above with reference to FIGS. 1-5 is cylindrical and the passageway 32, 232 extending along a length of the cylindrical central support member 230 is also cylindrical, the platform member 24, 224 is free to rotate relative to the support post. It is appreciated, however, that it might be desirable to prevent rotation of the platform assembly 24, 224 relative to the support post 18, 218. As such, and in accordance with an alternate embodiment disclosed with reference to FIG. 6, the cross section profiles of the support post 318 and the passageway 332 extending along a length of the cylindrical central support member 330 are non-circular (for example, D-shaped). The use of such a cross-sectional profile allows up/down movement of the platform assembly 324 relative to the support post 318 but prevents rotational movement of the platform assembly 324 relative to the support post 318. Such a construction could be implemented in conjunction with either the embodiment disclosed with reference to FIGS. 1 and 2 or the embodiment disclosed with reference to FIG. 3-5.

While the preferred embodiments have been shown and described, it will be understood that there is no intent to limit the invention by such disclosure, but rather, is intended to cover all modifications and alternate constructions falling within the spirit and scope of the invention.

1. An aquatic device, comprising:
a support post including a first end and a second end;
a platform assembly secured to the support post for movement relative thereto, the platform assembly including a platform member shaped and dimensioned to extend transversely to a longitudinal axis of the support post, a float member, and a central support member to which both the platform member and the float member are secured, the central support member including a passageway extending along a length of the central support member, the passageway being shaped and dimensioned to fit over the support post such that the platform assembly may freely move along the length of the support post;
wherein, and when the aquatic device is positioned within an aquarium with the support post extending toward an upper surface of water within the aquarium with the second end of the support post extending near or above the upper surface of water within the aquarium, buoyancy of the float member causes the float member to sit at the upper surface of water within the aquarium and thereby support the platform member at a position adjacent the upper surface of water within the aquarium.

2. The aquatic device according claim 1, wherein the support post is constructed as a straight, vertical rail.

3. The aquatic device according claim 1, wherein the support post is a one-piece construction.

4. The aquatic device according claim 1, wherein the float member is a plastic ball with air inside that can remain buoyant.

5. The aquatic device according to claim 1, wherein the float member is composed of foam and is integrally formed with the central support member.

6. The aquatic device according claim 1, wherein the platform member includes an upper surface and a lower surface.

7. The aquatic device according claim 1, wherein the platform member and the float member are positioned to allow for the platform member to remain partially submerged when in use.

8. The aquatic device according claim 1, wherein the center of gravity of the float member sits above the upper surface of the platform member.

9. The aquatic device according claim 1, wherein a center of gravity of the float member sits above the upper surface of the platform member a sufficient distance to allow the upper surface of the platform member to sit submerged just below the surface of the water a distance of ¾″ to 1″.

10. The aquatic device according to claim 1, further including a base member having an upper surface and a lower surface, and wherein the first end of the support post extends from the upper surface of the base member.

11. The aquatic device according claim 10, wherein the base member is a weighted support structure shaped and dimensioned to sit upon the floor of the aquarium.

12. The aquatic device according claim 11, wherein the base member takes the form of a rock.

13. The aquatic device according claim 1, wherein the platform member includes an upper surface facing away from the base member and a lower surface facing toward the base member.

14. The aquatic device according to claim 1, wherein the central support member is cylindrical.

15. The aquatic device according to claim 1, further including a mounting member for securing the support post to a wall of the aquarium.

16. The aquatic device according to claim 15, wherein the mounting member includes a support arm with a suction cup secured thereto.

17. The aquatic device according to claim 1, wherein cross section profiles of the support post and the passageway are non-circular allowing for up/down movement of the platform assembly relative to the support post but preventing rotational movement of the platform assembly relative to the support post.
